(19) United States
(12) Patent Application Publication
(10) Pub. No.: US 2007/0126964 A1
(43) Pub. Date: Jun. 7, 2007

(54) Transflective liquid crystal display device

(75) Inventors: Chiu-Lien Yang, Miao-Li (TW); Wei-Yi Ling, Miao-Li (TW); Chia-Lung Lin, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/633,161

(22) Filed: Dec. 4, 2006

(30) Foreign Application Priority Data
Dec. 2, 2005 (TW) 94142474

(51) Int. Cl. G02F 1/1335

(52) U.S. Cl. 349/119; 349/114

(57) ABSTRACT

An exemplary transflective LCD (20) device includes first and second substrates (210, 220); a liquid crystal layer (23) interposed between the substrates; a common electrode (211) disposed at an inner surface of the first substrate; a transmission electrode (221) and a reflection electrode (222) disposed at an inner surface of the second substrate, with the reflection electrode defining an opening therein; a first retardation film (251) and a first polarizer (241) disposed at an outside surface of the first substrate; a second retardation film (252) and a second polarizer (242) disposed at an outside surface of the second substrate; and a discotic molecular film (261 and 862) disposed in a position selected from the group consisting of, between the first retardation film and the first substrate, and between the second retardation film and the second substrate.

### CROSS-REFERENCE TO RELATED APPLICATION

This application is related to an application by CHIU-LIEN YANG, WEI-YI LING and CHIA-LUNG LIN entitled LIQUID CRYSTAL DISPLAY DEVICE, filed after Dec. 1, 2005 but before the present application, and assigned to the same assignee as that of the present application.

### FIELD OF THE INVENTION

The present invention relates to liquid crystal display (LCD) devices, and more particularly to a reflection/transmission type LCD device capable of providing a display both in a reflection mode and a transmission mode.

### BACKGROUND

Conventionally, there have been three types of LCD devices commercially available: a reflection type LCD device utilizing ambient light, a transmission type LCD device utilizing backlight, and a semi-transmission type LCD device equipped with a half mirror and a backlight.

With a reflection type LCD device, a display becomes less visible in a dim environment. In contrast, with a transmission type LCD device, a display becomes hazy in strong ambient light (e.g., outdoor sunlight). Thus researchers sought to provide an LCD device capable of functioning in both modes so as to yield a satisfactory display in any environment. In due course, a semi-transmission type LCD device was disclosed in Japanese Laid-Open Publication No. 7-333598.

However, the above-mentioned semi-transmission type LCD device typically has the following problems.

The semi-transmission type LCD device uses a half mirror in place of a reflective plate used in a reflection type LCD device, and has a minute transmission region (e.g., minute holes in a metal thin film) in a reflection region, thereby providing a display by utilizing transmitted light as well as reflected light. Since reflected light and transmitted light used for a display pass through the same liquid crystal layer, an optical path of reflected light is twice as long as that of transmitted light. This causes a large difference in retardation of the liquid crystal layer with respect to reflected light and transmitted light. Thus, a satisfactory display may not be obtained. Furthermore, a display in a reflection mode and a display in a transmission mode are superimposed on each other, so that the respective displays cannot be separately optimized. This results in difficulty in providing a color display, and tends to cause a blurred display.

Accordingly, what is needed is an LCD device that can overcome the above-described deficiencies.

### SUMMARY

A transflective LCD device includes a first and a second substrate; a liquid crystal layer having homogeneous alignment liquid crystal molecules interposed between the first and second substrates; a common electrode disposed at an inner surface of the first substrate; a transmission electrode and a reflection electrode disposed at an inner surface of the second substrate, with the reflection electrode defining an opening therein, wherein a portion of the transmission electrode at the opening, a corresponding portion of the common electrode, and the liquid crystal layer therebetween form a transmission region, and the reflection electrode, a corresponding portion of the common electrode, and the liquid crystal layer therebetween form a reflection region; a first retardation film and a first polarizer disposed at an outside surface of the first substrate; a second retardation film and a second polarizer disposed at an outside surface of the second substrate; and a discotic molecular film disposed in a position selected from the group consisting of, between the first retardation film and the first substrate, and between the second retardation film and the second substrate.

Other objects, advantages, and novel features will become more apparent from the following detailed description when taken in conjunction with the accompanying drawings.

### BRIEF DESCRIPTION OF THE DRAWINGS

FIG. 1 is a schematic, side cross-sectional view of part of a transflective LCD device according to a first embodiment of the present invention.

FIG. 2 shows a polarized state of light in each of certain layers of the transflective LCD device of FIG. 1, in respect of an on-state (no voltage applied) and an off-state (voltage applied) of the transflective LCD device, when the transflective LCD device operates in a reflection mode.

FIG. 3 shows a polarized state of light in each of certain layers of the transflective LCD device of FIG. 1, in respect of an on-state (no voltage applied) and off-state (voltage applied) of the transflective LCD device, when the transflective LCD device operates in a transmission mode.

FIG. 4 is a schematic, side cross-sectional view of selected layers of the transflective LCD device of FIG. 1, showing a discotic molecular film compensating a phase difference of a liquid crystal layer of the transflective LCD device while voltage is provided to the liquid crystal layer.

FIG. 5 is a schematic, side cross-sectional view of part of a transflective LCD device according to a second embodiment of the present invention.

FIG. 6 is a schematic, side cross-sectional view of part of a transflective LCD device according to a third embodiment of the present invention.

### DETAILED DESCRIPTION OF PREFERRED EMBODIMENTS

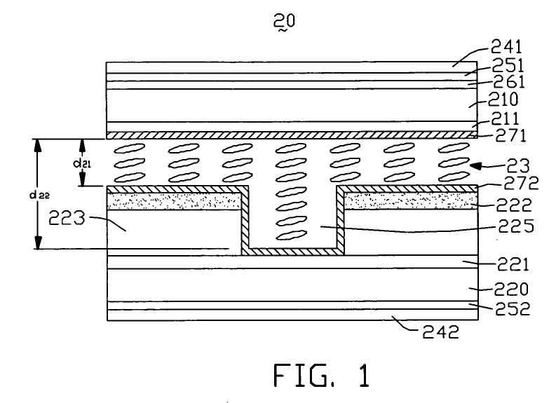

FIG. 1 is a schematic, side cross-sectional view of part of a transflective LCD device 20 according to a first embodiment of the present invention. The LCD device 20 includes a first substrate 210, a second substrate 220 disposed parallel to and spaced apart from the first substrate 210, and a liquid crystal layer 23 having liquid crystal molecules (not labeled) sandwiched between the substrates 210 and 220.

A common electrode 211 and a first alignment film 271 are disposed on an inner surface of the first substrate 210, in that order from top to bottom. A first discotic molecular film 261, a first retardation film 251, and a first polarizer 241 are disposed on an outer surface of the first substrate 210, in that order from bottom to top. A transmission electrode 221, an insulating layer 223, a reflection electrode 222, and a second alignment film 272 are disposed on an inner surface of the second substrate 220, in that order from bottom to top. The insulating layer 223 and the reflection electrode 222 include an opening 225. The second alignment film 272 covers the transmission electrode 221 at the opening 225. A second retardation film 252 and a second polarizer 242 are disposed on an outer surface of the second substrate 220, in that order from top to bottom.

The first alignment film 271 has a rubbing direction parallel to that of the second alignment film 272. An alignment direction of molecules of the first discotic molecular film 261 is parallel to the common rubbing direction of the alignment films 271 and 272. A pre-tilt angle of the molecules of the first discotic molecular film 261 adjacent to the first substrate 210 is in the range from 0° to 45°, and a pre-tilt angle of the molecules of the first discotic molecular film 261 adjacent to the first retardation film 251 is in the range from 45° to 90°. The molecules of the first discotic molecular film 261 are negative liquid crystal molecules having a negative phase difference.

A polarizing axis of the first polarizer 241 is perpendicular to that of the second polarizer 242. A slow axis of the first retardation film 251 maintains an angle of 45° relative to the polarizing axis of the first polarizer 241, and a slow axis of the second retardation film 252 maintains an angle of 45° relative to the polarizing axis of the second polarizer 242. The slow axis of the first retardation film 251 is perpendicular to that of the second retardation film 252. The first and second retardation films 251 and 252 are preferably quarter-wave plates.

A portion of the transmission electrode 221 corresponding to the opening 225, a corresponding portion of the common electrode 211, and a corresponding portion of the liquid crystal layer 23 contained therebetween form a transmission region. The reflection electrode 222, a corresponding portion of the common electrode 211, and a corresponding portion of the liquid crystal layer 23 contained therebetween form a reflection region. The reflection electrode 222 is made of metal with a high reflective ratio, such as aluminum (Al) or an aluminum-neodymium (Al—Nd) alloy. The transmission electrode 221 and the common electrode 211 are made of a transparent conductive material, such as indium-tin-oxide (ITO) or indium-zinc-oxide (IZO).

The liquid crystal layer 23 in the transmission region has a thickness d22, and the liquid crystal layer 23 in the reflection region has a thickness d21. Typically, a retardation value of the liquid crystal layer 23 in the transmission region is in the range from 130 nm˜350 nm, and a retardation value of the liquid crystal layer 23 in the reflection region is in the range from 65˜175 nm. The liquid crystal molecules of the liquid crystal layer 23 are positive type liquid crystal molecules. The liquid crystal layer 23 is a homogeneous alignment liquid crystal layer.

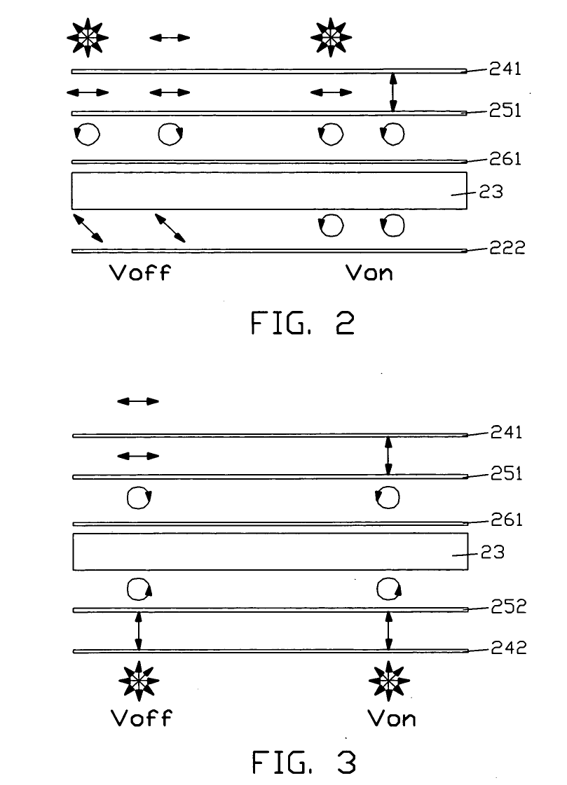

FIG. 2 shows a polarized state of light in each of certain layers of the LCD device 20 when the LCD device 20 operates in a reflection mode. When no voltage is applied to the LCD device 20, the LCD device 20 is in an on-state (white state). Ambient incident light becomes linearly-polarized light having a polarizing direction parallel to that of the first polarizer 241 after passing through the first polarizer 241. Thereafter, the linear-polarized light is incident upon the first retardation film 251 (a quarter-wave plate), and becomes circularly-polarized light. Then the circularly-polarized light is incident on the first discotic molecular film 261 and liquid crystal layer 23. Since an effective phase difference of the first discotic molecular film 261 and the liquid crystal layer 23 in an on-state is configured to be a wavelength of λ/4 in order to obtain a white display, the incident circularly-polarized light becomes linearly-polarized light. The linearly-polarized light exiting the liquid crystal layer 23 is reflected by the reflection electrode 222. The linearly-polarized light keeps its polarized state, and is incident on the liquid crystal layer 23 again. The linearly-polarized light passing through the liquid crystal layer 23 becomes circularly-polarized light having a polarizing direction opposite to that of the circularly-polarized light originally incident on the liquid crystal layer 23. The circularly-polarized light exiting the liquid crystal layer 23 is converted to linearly-polarized light by the first retardation film 251, and is output through the first polarizer 241 for displaying images.

On the other hand, when a voltage is applied to the LCD device 20, the LCD device 20 is in an off-state (black state). Up to the point where ambient incident light reaches the liquid crystal layer 23, the ambient incident light undergoes transmission in substantially the same way as described above in relation to the LCD device 20 being in the on-state. Since an effective phase difference of the first discotic molecular film 261 and the liquid crystal layer 23 is configured to be 0 by applying a voltage in order to obtain a black display, the circularly-polarized light incident on the first discotic molecular film 261 and liquid crystal layer 23 passes therethrough as circularly-polarized light. The circularly-polarized light exiting the liquid crystal layer 23 is reflected by the reflection electrode 222. The circularly-polarized light keeps its polarized state, and is incident on the liquid crystal layer 23 again. After passing through the liquid crystal layer 23 and first discotic molecular film 261 unchanged, the circularly-polarized light is converted into linearly-polarized light by the first retardation film 251 (a quarter-wave plate). At this time, the polarizing direction of the linearly-polarized light is rotated by about 90° compared with that of a white display state. Then the linearly-polarized light is absorbed by the first polarizer 241. Thus the linearly-polarized light is not output from the LCD device 20 for displaying images.

FIG. 3 shows a polarized state of light in each of certain layers of the LCD device 20 for an on-state (white state) and an off-state (black state) when the LCD device 20 operates in a transmission mode. Incident light undergoes transmission in a manner similar to that described above in relation to the LCD device 20 operating in the reflection mode. An effective phase difference of the first discotic molecular film 261 and liquid crystal layer 23 in an on-state is configured to be a wavelength of λ/2. An effective phase difference of the first discotic molecular film 261 and liquid crystal layer 23 in an off-state is configured to be 0.

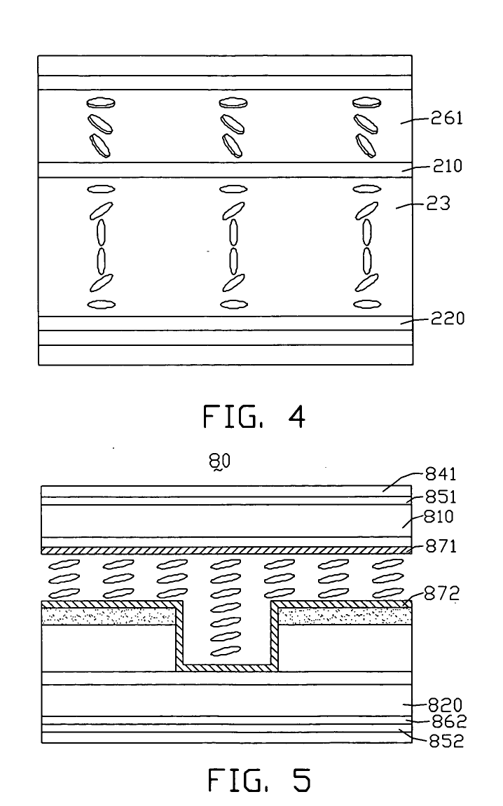

FIG. 4 shows a principle of the first discotic molecular film 261 compensating a phase difference of the liquid crystal layer 23 of the transflective LCD device 20 while a voltage is provided to the liquid crystal layer 23. The liquid crystal molecules of the liquid crystal layer 23 may not be completely perpendicular to the substrates 210 and 220 while a voltage is provided thereto. Some of the liquid crystal molecules maintain an angle relative to the substrates 210 and 220, with the angle generally decreasing along a direction from a middle of the liquid crystal layer 23 toward the substrate 210, and similarly generally decreasing along a direction from the middle of the liquid crystal layer 23 toward the substrate 220. The molecules of the first discotic molecular film 261 also maintain a pre-tilt angle relative to the substrates 210 and 220. The liquid crystal molecules of the liquid crystal layer 23 have a positive phase difference, and the molecules of the first discotic molecular film 261 have a negative phase difference. The positive and negative phase differences counteract each other so as to compensate the effective phase difference of the liquid crystal layer 23.

With the above-described configuration, the first discotic molecular film 261 can compensate for any phase difference of the liquid crystal layer 23 due to the liquid crystal molecules of the liquid crystal layer 23 not being completely perpendicular to the substrates 210 and 220 when a voltage is provided to the liquid crystal layer 23. This reduces leakage of light when the LCD device 20 in the off-state, and thereby increases a contrast of images displayed by the LCD device 20. Moreover, the first discotic molecular film 261 can compensate contrast and color-shift of the LCD device 20 according to different viewing angles, so as to improve a wide viewing angle performance of the LCD device 20.

FIG. 5 is a schematic, side cross-sectional view of part of a transflective LCD device 80 according to a second embodiment of the present invention. The LCD device 80 has a structure similar to the LCD device 20. However, the LCD device 80 includes a second discotic molecular film 862 disposed between a second retardation film 852 and a second substrate 820. Further, only a first retardation film 851 and a first polarizer 841 are disposed on an outer surface of a first substrate 810.

An alignment direction of molecules of the second discotic molecular film 862 is parallel to that of alignment films 871 and 872. A pre-tilt angle of molecules of the second discotic molecular film 862 adjacent to the second substrate 820 is in the range from 0° to 45°, and a pre-tilt angle of molecules of the second discotic molecular film 862 adjacent to the second retardation film 852 is in the range from 45° to 90°.

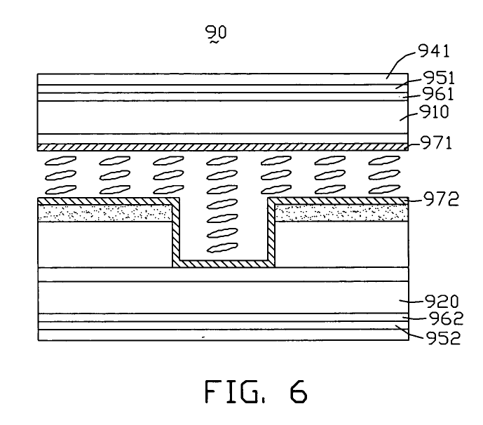

FIG. 6 is a schematic, side cross-sectional view of part of a transflective LCD device 90 according to a third embodiment of the present invention. The LCD device 90 has a structure similar to the LCD device 20. However, the LCD device 90 further includes a second discotic molecular film 962 disposed between a second retardation film 952 and a second substrate 920. A first discotic molecular film 961, a first retardation film 951, and a first polarizer 941 are disposed on an outer surface of a first substrate 910, in that order from bottom to top.

An alignment direction of molecules of the second discotic molecular film 962 is parallel to that of alignment films 971 and 972. A pre-tilt angle of molecules of the first discotic molecular film 961 adjacent to the first substrate 910 is the range from 0° to 45°. In this exemplary embodiment, the pre-tilt angle is 40°. A pre-tilt angle of molecules of the first discotic molecular film 961 adjacent to the first retardation film 951 is in the range from 45° to 90°. In this exemplary embodiment, the pre-tilt angle is 89°. A pre-tilt angle of molecules of the second discotic molecular film 962 adjacent to the second substrate 920 is the range from 0° to 45°. In this exemplary embodiment, the pre-tilt angle is 40°. A pre-tilt angle of molecules of the second discotic molecular film 962 adjacent to the second retardation film 952 is in the range from 45° to 90°. In this exemplary embodiment, the pre-tilt angle is 89°. The molecules of the first and second discotic molecular films 961 and 962 are negative liquid crystal molecules having a negative phase difference.

It is to be understood, however, that even though numerous charcteristics and advantages of the present embodiments have been set out in the forgoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A transflective liquid crystal display device, comprising:
a first substrate and a second substrate;
a liquid crystal layer having liquid crystal molecules interposed between the first and second substrates, the liquid crystal layer being a homogeneous alignment liquid crystal layer;
a common electrode disposed at an inner surface of the first substrate;
a transmission electrode and a reflection electrode disposed at an inner surface of the second substrate, with the reflection electrode defining an opening therein, wherein a portion of the transmission electrode at the opening, a corresponding portion of the common electrode, and the liquid crystal layer therebetween form a transmission region, and the reflection electrode, a corresponding portion of the common electrode, and the liquid crystal layer therebetween form a reflection region;
a first retardation film and a first polarizer disposed at an outside surface of the first substrate;
a second retardation film and a second polarizer disposed at an outside surface of the second substrate; and
at least one discotic molecular film disposed in a position selected from the group consisting of, between the first retardation film and the first substrate, and between the second retardation film and the second substrate.

2. The transflective liquid crystal display device as claimed in claim 1, wherein the at least one discotic molecular film comprises a first discotic molecular film disposed between the first retardation film and the first substrate.

3. The transflective liquid crystal display device as claimed in claim 2, wherein a retardation value of the liquid crystal layer in the transmission region is in the range from 130 nm˜350 nm, and a retardation value of the liquid crystal layer in the reflection region is in the range from 65˜175 nm.

4. The transflective liquid crystal display device as claimed in claim 2, wherein the liquid crystal molecules are positive type liquid crystal molecules.

5. The transflective liquid crystal display device as claimed in claim 2, further comprising a first alignment film disposed between the liquid crystal layer and the first substrate, and a second alignment film disposed between the liquid crystal layer and the second substrate, wherein a rubbing direction of the first alignment film is parallel to that of the second alignment film.

6. The transflective liquid crystal display device as claimed in claim 5, wherein an alignment direction of molecules of the first discotic molecular film is parallel to the rubbing direction of the first and second alignment films.

7. The transflective liquid crystal display device as claimed in claim 6, wherein a pre-tilt angle of the molecules of the first discotic molecular film adjacent to the first substrate is in the range from 0° to 45°, and a pre-tilt angle of the molecules of the first discotic molecular film adjacent to the first retardation film is in the range from 45° to 90°.

8. The transflective liquid crystal display device as claimed in claim 2, wherein the molecules of the first discotic molecular film are negative type liquid crystal molecules.

9. The transflective liquid crystal display device as claimed in claim 2, wherein the first and second retardation films are quarter-wave plates, and a slow axis of the first retardation film is perpendicular to that of the second retardation film.

10. The transflective liquid crystal display device as claimed in claim 9, wherein the first polarizer has a polarizing direction perpendicular to that of the second polarizer, the polarizing direction of the first polarizer maintains an angle of 45° relative to the slow axis of the first retardation film, and the polarizing direction of the second polarizer maintains an angle of 45° relative to the slow axis of the second retardation film.

11. The transflective liquid crystal display device as claimed in claim 7, wherein the at least one discotic molecular film further comprises a second discotic molecular film disposed between the second retardation film and the second substrate.

12. The transflective liquid crystal display device as claimed in claim 11, wherein an alignment direction of molecules of the second discotic molecular film is parallel to the rubbing direction of the first and second alignment films.

13. The transflective liquid crystal display device as claimed in claim 12, wherein a pre-tilt angle of the molecules of the second discotic molecular film adjacent to the second substrate is in the range from 0° to 45°, and a pre-tilt angle of the molecules of the second discotic molecular film adjacent to the second retardation film is in the range from 45° to 90°.

14. The transflective liquid crystal display device as claimed in claim 12, wherein the molecules of the second discotic molecular film are negative type liquid crystal molecules.

15. The transflective liquid crystal display device as claimed in claim 1, wherein the at least one discotic molecular film is a single discotic molecular film disposed between the second retardation film and the second substrate.

16. The transflective liquid crystal display device as claimed in claim 15, wherein a pre-tilt angle of the molecules of the discotic molecular film adjacent to the second substrate is in the range from 0° to 45°, and a pre-tilt angle of the molecules of the discotic molecular film adjacent to the second retardation film is in the range from 45° to 90°.

17. The transflective liquid crystal display device as claimed in claim 16, wherein the molecules of the discotic molecular film are negative type liquid crystal molecules.

18. A transflective liquid crystal display device comprising:
a first substrate and a second substrate;
a liquid crystal layer having liquid crystal molecules interposed between the first and second substrates, the liquid crystal layer being a homogeneous alignment liquid crystal layer; and
at least one discotic molecular film disposed on an exterior surface of said first substrate or said second substrate, molecules of the discotic molecular film maintain a pre-tilt angle relative to the first and second substrates.

19. The transflective liquid crystal display as claimed in claim 18, wherein an effective phase difference of the discotic molecular film and liquid crystal layer in an on-state is configured to be a wavelength of λ/2, and an effective phase difference of the discotic molecular film and liquid crystal layer in an off-state is configured to be zero.
